(19) United States
(12) Patent Application Publication
(10) Pub. No.: US 2024/0020884 A1
(43) Pub. Date: Jan. 18, 2024

(54) ONLINE META LEARNING FOR META-CONTROLLED SR IN IMAGE AND VIDEO COMPRESSION

(71) Applicant: Alibaba Damo (Hangzhou) Technology Co., Ltd., Hangzhou (CN)

(72) Inventors: Yan Ye, San Diego, CA (US); Wei Jiang, San Mateo, CA (US); Wei Wang, San Mateo, CA (US)

(21) Appl. No.: 18/221,388

(22) Filed: Jul. 13, 2023

Related U.S. Application Data
(60) Provisional application No. 63/389,576, filed on Jul. 15, 2022.

(51) Int. Cl. G06T 9/00; G06T 3/40

(52) U.S. Cl. CPC G06T 9/00; G06T 3/4053

(57) ABSTRACT

A method for learned image compression is provided. The method may include receiving first image data; downsampling the first image data to second image data; encoding the second image data to third image data, the third image data being a bitstream; decoding the third image data to fourth image data; and reconstructing, as reconstructed image data, the first image data based at least in part on the fourth image data and a feature vector.

### CROSS REFERENCE TO RELATED PATENT APPLICATION

This application claims the benefit of U.S. Provisional Patent Application No. 63/389,576, entitled “Online Meta Learning For Meta-Controlled SR In Image and Video Compression” and filed Jul. 15, 2022, which is expressly incorporated herein by reference in its entirety.

### BACKGROUND

In 2022, working group 1 of the coding of audio, picture, multimedia and hypermedia information subcommittee of the ISO/IEC Joint Technical Committee (“ISO/IEC JTC 1/SC 29/WG 1”) and ITU-T Study Group 16 (“ITU-T SG16”) are convening to review proposals for JPEG AI, a new learning-based coding standard for images. Machine learning tools will be incorporated into this new standard to achieve further improvements in compression efficiency over prior standards such as JPEG, JPEG2000, as well as intra-frame coding used in video coding standards such as H.264/AVC (Advanced Video Coding) and H.265/HEVC (High Efficiency Video Coding), and, most recently, Versatile Video Coding (“VVC”). Furthermore, learning-based coding has the potential to be a part of future video coding standards succeeding VVC as well.

Present image coding techniques are primarily based on lossy compression and a framework including transform coding, quantization, and entropy coding. For many years, lossy compression has achieved compression ratios which are suited to image capture and image storage at limited scales. However, computer systems are increasingly configured to capture and store images at much larger scales, for applications such as surveillance, streaming, data mining, and computer vision. As a result, it is desirable for future image coding standards to achieve even smaller image sizes without greatly sacrificing image quality.

Machine learning has not been a part of past image coding standards, whether in the compression of still images or in intra-frame coding used in video compression. As recently as the VVC standardization process from 2018 to 2020, working groups of the ISO/IEC and ITU-T reviewed, but did not adopt, learning-based coding proposals. There remains a need to improve image compression techniques by designing novel machine learning techniques which further improve the balance of image quality and image size, while also improving the computational efficiency of image coding.

### BRIEF DESCRIPTION OF THE DRAWINGS

Example embodiments of the present disclosure provide learned image compression (“LIC”) techniques implemented to be compatible with image compression according to the JPEG AI image coding standard, as well as intra-frame coding according to video coding standards.

FIG. 1 illustrates a block diagram of an image compression process.

FIG. 2 illustrates an example workflow of image/video compression based on super-resolution (SR).

FIG. 3 illustrates an example workflow of a test stage of encoder for online meta-controlled SR according to the present disclosure.

FIG. 4 illustrates an example workflow of a test stage of decoder for online meta-controlled SR according to the present disclosure.

FIG. 5 illustrates an example embodiment of the network structure for the meta-control injected SR according to the present disclosure.

FIG. 6 illustrates an example embodiment of the modulated residual block (MRB) architecture according to the present disclosure.

FIG. 7 illustrates an example system for implementing the processes and methods described herein for implementing online meta learning for meta-controlled SR in image and video compression.

### DETAILED DESCRIPTION

According to example embodiments of the present disclosure, a system for image and video compression, comprising: a downsampling module configured to receive, from an image capturing device, first image data; and an encoding-decoding scheme including: an encoder module configured to encode second image data to third image data; a decoder module configured to decode the third image data to fourth image data; and an image reconstruction module configured to reconstruct, as reconstructed image data, the first image data based at least in part on the fourth image data and a feature vector.

According to example embodiments of the present disclosure, the system further comprises a weight generation module configured to obtain a set of parameters indicating a compression quality of the fourth image data and generate a weight vector based at least in part on the set of parameters.

According to example embodiments of the present disclosure, the system further comprises a kernel dictionary generation module configured to generate a stack of kernels based at least in part on the weight vector; and a feature generation module configured to generate the feature vector based at least in part on the stack of kernels.

According to example embodiments of the present disclosure, the system further comprises a distortion loss value computing module configured to compute a distortion loss value based at least in part on the first image data and the reconstructed image data; a step size determining module configured to determine a step size based at least in part on the distortion loss value; and a parameter updating module configured to update the set of parameters based at least in part on the distortion loss value and the step size.

According to example embodiments of the present disclosure, the encoding-decoding scheme is configured to be performed iteratively until a criterion is satisfied, wherein the criterion includes at least one of: a number of iterations, or a minimum distortion loss value.

According to example embodiments of the present disclosure, encoding the second image data to the third image data and decoding the third image data to the fourth image data use one or more compression methods of JPEG, JPEG 2000, H.264/MPEG4, H.265/HEVC, VCC, DNN-based learned image compression method, or DNN-based learned video compression method.

According to example embodiments of the present disclosure, the first image data may include at least one of an image, a video frame, or a sequence of video frames.

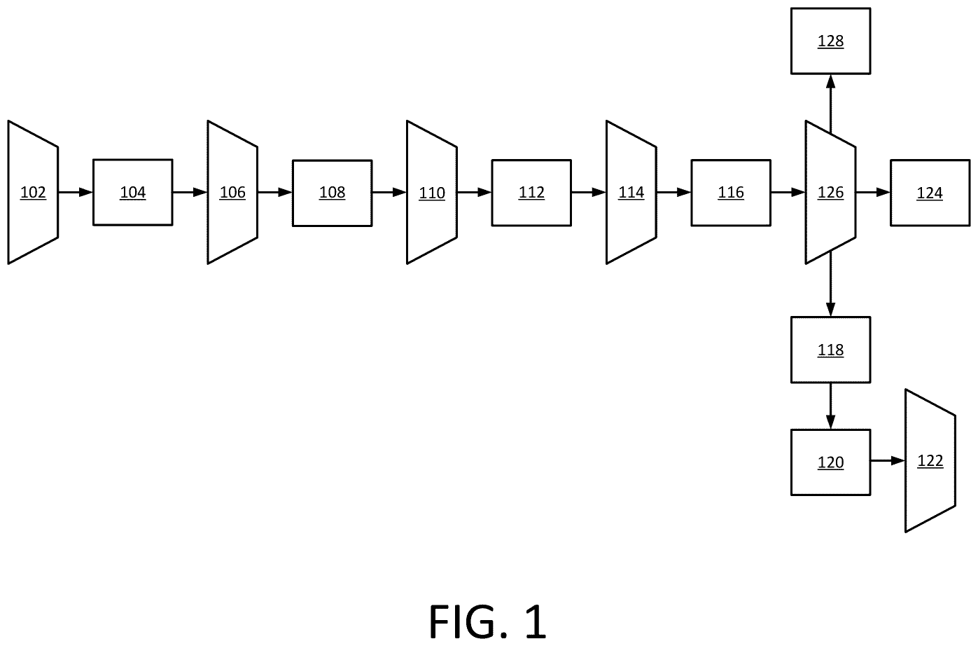

FIG. 1 illustrates a block diagram of an image compression process. The image compression process as illustrated may be implemented by a variety of still image coding techniques, such as those implemented by JPEG, JPEG2000, and all JPEG AI proposals, as well as a variety of intra-frame coding techniques, such as those implemented by AVC, HEVC, and VVC. The image compression process can include at least one of lossless steps or lossy steps.

It should be understood that the image compression process, while conforming to each of the above-mentioned standards (and to other image coding standards or techniques based on image compression, without limitation thereto), does not describe the entirety of each of the above-mentioned standards (or the entirety of other image coding standards or techniques). Furthermore, the elements of the image compression process 100 can be implemented differently according to each of the above-mentioned standards (and according to other image coding standards or techniques), without limitation.

According to the image compression process, as illustrated in FIG. 1, a computing system may be configured by one or more sets of computer-executable instructions to perform a plurality of operations on an input picture 102. First, the computing system may perform a transform operation 104 on the input picture 102. Herein, one or more processors of the computing system may transform picture data from a spatial domain representation (i.e., picture pixel data) into a frequency domain representation by a Fourier transform computation such as discrete cosine transform (“DCT”). In a frequency domain representation, the transformed picture data is represented by transform coefficients 106.

According to the image compression process, as illustrated in FIG. 1, the computing system may then perform a quantization operation 108 upon the transform coefficients 106. Herein, one or more processors of the computing system may generate a quantization index 110, which may store a limited subset of the color information stored in picture data.

The computing system may then perform an entropy encoding operation 112 upon the quantization index 110. Herein, one or more processors of the computing system may perform a coding operation, such as arithmetic coding, wherein symbols may be coded as sequences of bits depending on their probability of occurrence. The entropy encoding operation 112 may yield a compressed picture 114.

The computing system may be further configured by one or more sets of computer-executable instructions to perform operations upon the compressed picture 114 to output the compressed picture.

For example, according to some image coding standards, the computing system may perform an entropy decoding operation 116, a de-quantization operation 118, and an inverse transform operation 120 upon the compressed picture 114 to output a reconstructed picture 122.

Furthermore, according to the JPEG AI standard, the computing system may be configured to output the compressed picture 114 in formats other than a reconstructed picture. Prior to performing the inverse transform operation 120, or instead of performing the inverse transform operation 120, the computing system may be configured to perform an image processing operation 124 upon a decoded picture 126 yielded by the entropy decoding operation 116.

By way of example and not limitation, one or more processors of the computing system may resize a decoded picture, rotate a decoded picture, reshape a decoded picture, crop a decoded picture, rescale a decoded picture in any or all color channels thereof, shift a decoded picture by some number of pixels in any direction, alter a decoded picture in brightness or contrast, flip a decoded picture in any orientation, inject noise into a decoded picture, reweigh frequency channels of a decoded picture, apply frequency jitter to a decoded picture, and the like.

Prior to performing the inverse transform operation 120, or instead of performing the inverse transform operation 120, the computing system may be configured to input a decoded picture 126 into a learning model 128. One or more processors of a computing system may input the decoded picture 126 into any layer of a learning model 128, which may further configure the one or more processors to perform training or inference computations based on the decoded picture 126.

According to an image or video coding standard, the computing system may perform any, some, or all of outputting a reconstructed picture 122, performing an image processing operation 124 upon a decoded picture 126, and inputting a decoded picture 126 into a learning model 128, without limitation.

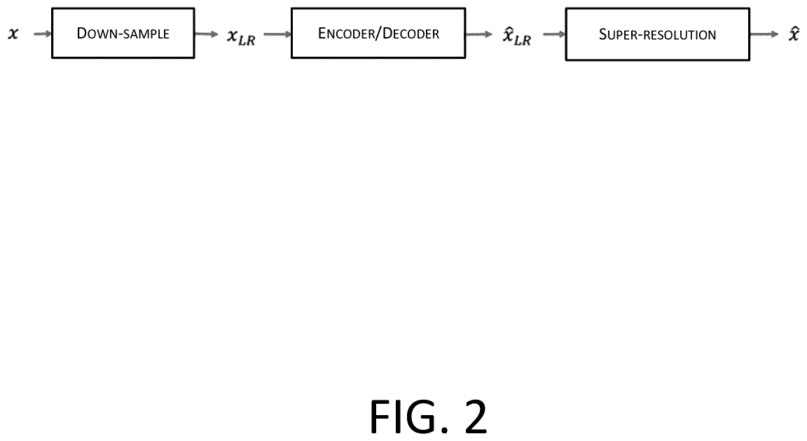

FIG. 2 illustrates an example workflow of image/video compression based on super-resolution (SR).

As illustrated in FIG. 2, an input x, which may be an image, a video frame, or a sequence of video frames, may be inputted through a Down-Sample module. The resolution of the input x may be reduced by the Down-Sample module to generate a low-resolution input x_{LR}. The low-resolution input x_{LR} may further be inputted to an Encoder/Decoder. The Encoder/Decoder may use a compression method to compress, transmit, and decompress the low-resolution input x_{LR}, and generate a decoded low-resolution \hat{x}_{LR}.

By way of example and without limitation, the compression method that the Encoder/Decoder uses may include any traditional video coding methods such as VVC, DNN-based learned image compression method, or DNN-based learned video compression method.

The decoded low-resolution \hat{x}_{LR} may be further inputted into Super-Resolution module. The Super-Resolution module may generate a reconstructed high-resolution output \hat{x} from \hat{x}_{LR} as \hat{x}=g_{θ}(\hat{x}_{LR}). The learning target of the Super-Resolution module, whose model parameters are denoted by θ, is to minimize the distortion loss D(x,\hat{x}) between the original input x and the reconstructed high-resolution output \hat{x}.

$${min}_{θ} {E}_{p ( x )} D ( x , {g}_{θ} , ( {\hat{x}}_{LR} ) ) \qquad ( 1 )$$

As shown in Equation (1), p(x) is the probability density function of all natural images. The distortion loss D(x,\hat{x}) may include one or a combination of mean square error (MSE), mean absolute error (MAE), and perceptual losses.

By compressing and transmitting the low-resolution version x_{LR} instead of the original input x, the required bitrate of the transmission may be automatically reduced. The performance of the compression framework, as illustrated in FIG. 2, may rely on the success of the Super-Resolution module to reconstruct the high-resolution output R.

Blind Super-Resolution or reference-free blind SR may be another image/video compression method. Blind SR or reference-free blind SR has been largely explored in the literature, and great progress has been made by DNN-based methods using the large-scale external training samples. Most SR algorithms rely on the specific condition of the supervised data with known degradation model, such as the bi-cubic down-sampling with additive noise. However, such degradation model usually does not apply to real-world images that are degenerated in various ways. This domain gap results in inferior results and undesirable artifacts.

To address this issue, zero-shot super-resolution (ZSSR) is proposed based on the zero-shot self-learning setting. By using deep self-learning, the non-local structure of the test image is exploited to improve the performance of a trained model over regions where the recurrences are salient. However, thousands of iterative gradient updates are usually required for such method to get a reasonable performance, which makes it impractical for real image/video compression.

Style-conditioned generator with generative adversarial networks is yet another image/video compression method. Generative Adversarial Networks (GAN) are successfully used for image generation. By training a generative model together with a competing adversarial discriminator, high quality images can be generated from a random vector drawn from a learned latent space. One most important extension is the conditional GAN, where an output image is generated conditionally when provided with some additional input conditions, such as image categories.

One most popular application for conditional GAN is style transfer in image-to-image translation, where an image is translated across different domains to have different styles. StyleGAN-based methods give the state-of-the art performances for such tasks, where a latent space that separates the style (e.g., color and texture) and content (e.g., structure) are learned. Then, starting from a learned constant input, the style-controlling latent code of the image may be adjusted to generate outputs of the desired style with noise injection.

Online learning is yet another image/video compression method. Online learning aims to improve generalization of machine learning models, i.e., to alleviate the problem caused by different training and test data distributions. Most online learning methods focus on online updating the learned models, and their performance with DNNs for online deep learning is quite limited. This is because the highly complex DNN models need to be trained with batch-based methods using mini-batches and multiple passes over the training data. Updating model parameters on the per-sample basis can be highly unstable.

Meta learning is yet another image/video compression method. Meta-learning aims to learn from the experience of a set of machine learning tasks so that learning of a new task can be fast. For example if tasks are drawn from a task distribution, and a set of training tasks with their corresponding datasets are observed, a meta-learning algorithm may try to learn a task-general prior over the model parameters. Such prior knowledge may be applied to a new task to speed up the learning. Among various meta-learning methods, the gradient-based Model-Agnostic Meta-Learning (MAML) is successfully used in various applications including reinforcement learning and HDR image reconstruction.

Online meta learning is yet another image/video compression method. For the scenario of continual learning, where the task distribution is not fixed but changing overtime, the online meta-learning (OML) framework is developed, where the MAML meta-training with direct Stochastic Gradient Descent (SGD) is performed online during a task sequence to update the learned model parameters of the task model. However, existing OML framework suffers from the same problem of online learning where online updating the learned model based on a single test datum does not perform well for DNN models in general.

Great success is achieved by blind super-resolution methods based on DNNs that leverage large-scale external data through extensive training. However, the success of SR algorithms relies on the specific condition of the supervised data with known degradation model, such as the bi-cubic down-sampling with additive noise. Such degradation model usually does not apply to real-world images that are degenerated in various ways. This domain gap results in inferior results and undesirable artifacts.

In the context of image and video compression, in nature, a compression model may pursue a balance between the reconstruction quality and the bitrate through the Rate-Distortion loss. The compress quality of a compression method may be determined by a number of factors, including, but not limited to, a desired trade-off between bitrate and reconstruction quality, a desired trade-off between computation and RD performance, etc. One set of such factors (denoted by hyperparameter λ in this disclosure) may generate compression results of one compression quality, and the set of factors may control the quality of the decoded low-resolution input \hat{x}_{LR} for the SR method. As a result, one set of model parameters θ may usually need to be trained for each set of factors λ. It is not only inefficient but also inflexible, since it is impossible to train one SR model for every possible λ, which can take arbitrary value.

From another perspective, SR of the compressed low-resolution data with compression quality controlled by each λ may be treated as a task, by observing training tasks of multiple compression qualities, meta learning enables fast generalization to a new test compression quality. This provides a potential solution to solve the above issue of inflexibility.

In addition, the problem of image and video compression is well suited for online learning, since the target is to encode and recover the input image or video itself, and the encoder has the ground-truth input at test time. Online learning can help bridge the gap between the mismatched training and test data distributions or the mismatched training and test compression quality targets.

The present disclosure provides an Online Meta Learning (OML) mechanism for image and video compression based on the SR framework illustrated in FIG. 1. The OML mechanism according to the present disclosure may learn, from the multiple training tasks of SR over low-resolution data that are generated by a compression method with different control factors, a set of task-general meta parameters that are controlled by meta-control variables A. The nature of SR in image and video compression is to reverse the degradation caused by both down-sampling and compression. Thus, more information about the degradation kernel yields better results in reconstructing the image. The task-general meta parameters may play the role of mapping between the meta-control variables and the degradation kernels. For a specific test datum, only the few meta-control variables A may need to be adaptively determined and transmitted on the fly based on the learned mapping to improve the current SR reconstruction for the current test datum.

According to the present disclosure, the online learning mechanism may make use of the ground-truth in the encoder to tune the SR process for each particular test datum, which helps to bridge the gap between the training-test mismatch. The meta-learning mechanism may enable effective adaptation for online learning in SR for image and video compression.

In example implementations, if the tasks of SR over decoded low-resolution that is compressed with different control factors λ are drawn from a task distribution T, M tasks with M sets of control factors λ₁, . . . , λ_{M} may be observed at meta-training time. A new task with an arbitrary target λₜ may be observed at meta-test time. By learning from the training tasks, meta-learning-based SR may aim to optimize the distortion loss for λₜ, without regular large-scale training for λₜ.

Let Ø={Øᵢ^{k}} include all the model parameters shared by different tasks that are learned from the training tasks. Let L(dⱼ, λⱼ, Ø) represent the average loss on the dataset dⱼ for control factors λⱼ. The MAML method may learn an initial set of parameters Ø based on all the training tasks, by solving the following optimization problem:

$${min}_{∅} {\sum }_{j = 1}^{M} L ( {d}_{j} , {λ}_{j} , ∅ - αΔ {\hat{L}}_{j} ( ∅ , {λ}_{j} ) ) \qquad ( 2 )$$

As shown in Equation (2), Δ\hat{L}ⱼ(Ø,λⱼ) is the inner gradient computed based on a small mini-batch of dataset dⱼ, and α is the step size for updating model parameters. At meta-test time, L(dₜ,λₜ,Ø) may be minimized by performing a number of steps of gradient descent from the initial set of parameters Ø using new task data dₜ. However, in the context of online SR, the current task is to restore from the test low-resolution input image \hat{x}_{LR} with dₜ=\hat{x}_{LR}. Updating model parameters Ø is unstable. According to the present disclosure, instead of updating the model parameters Ø, the set of learned meta-control variables Λ may be updated online.

In some examples, a dictionary-based meta-SR network may be implemented. Under the assumption that for each type of degradation corresponding to each compression quality controlled by each λ, the degradation kernel comes from a common dictionary of possible degradation kernels [symbol] that is shared across different compression qualities. For a particular compression quality controlled by the meta-control variable A t, an importance weight wₜⱼ may be assigned to each kernel Kⱼ in the common dictionary. This weight wₜⱼ may be computed from λₜ and a weight vector wₜ=[wₜ₁, . . . , w_{t|} [symbol] _{|}] may be formed for the whole dictionary. Each kernel may be weighted by the corresponding weight element, and all these weighted kernels may be stacked together into a feature map F_{λ}_{ₜ} of size [symbol] ×k×k, where k is the kernel size and | [symbol] | is the size of the dictionary. This feature map may further be processed to compute a meta-control feature vector V_{λ}_{ₜ} which may be used by the SR reconstruction network in decoder to help recover the high-resolution data.

The meta-control feature vector V_{λ}_{ₜ} may carry information about the degeneration process for the meta distribution corresponding to the meta-control variable λₜ. Through meta-training, a mapping relation may be learned to influence the reconstruction through this meta-control vector as a control proxy, and at test time, the meta-control variable λₜ may be quickly adapted, to tune the generated meta-control feature vector and tune the reconstruction of the current test datum.

A style-based generation method may be proposed to make the reconstruction process conditioned on the meta-control vector. Decoded data with different compression qualities may be treated as having different styles. In example implementations, the original input x may be compressed to have different styles (qualities) yet the same content. For each style corresponding to the meta-control variable λₜ, the computed meta-control feature vector V_{λ}_{ₜ} may carry the style information. Then, a modulated convolution method based on the weight modulation layer from StyleGAN may be used in the SR network for meta-controlled reconstruction.

In example implementations, a mapping between the meta-control variable A t and the reconstruction process may be established during the training process. Then, in the test stage, for the current low-resolution input datum \hat{x}_{LR}, on the encoder side, an online distortion loss L(dₜ,λₜ,Ø) may be computed based on the original input x and the reconstructed \hat{x}. Further, the gradient of the online distortion loss may be directly used to update the meta-control through online Stochastic Gradient Descent (SGD):

λₜ^{k}=λₜ^{k}−γΔ_{λ}_{ₜ}_{^{k}}L(dₜ,λₜ,Ø), for λₜ^{k}∈Λ (3)

As shown in Equation (3), γ is the step size for updating the meta-control variables, and Δ_{λ}_{ₜ}_{^{k}}L(dₜ,λₜ,Ø) is the partial gradient of L(dₜ,λₜ,Ø) against a variable λₜ^{k} in Λ. λₜ^{k} is initialized as λₜ. The direct SGD may find a better set of meta-control variables Λ* than the original λₜ, so that a better distortion loss L(dₜ,Λ*,Ø) may be obtained. Different from the original meta-control injected SR, with λₜ being the same across all layers where the meta-control parameters influence the conditioned generation process, the online meta-controlled SR may have a different λₜ^{k} learned from online SGD for each k-th meta-controlled layer that uses modulated convolution.

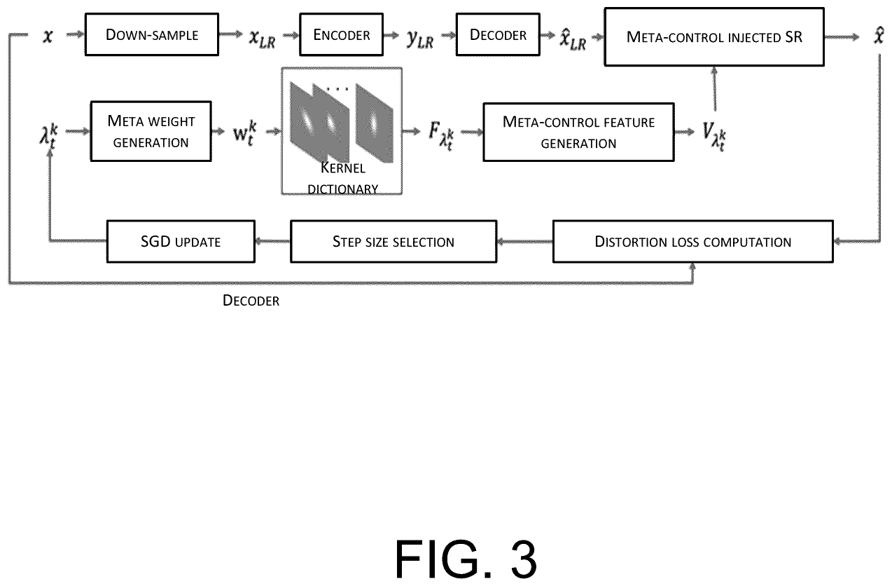

FIG. 3 illustrates an example workflow of a test stage of encoder for online meta-controlled SR according to the present disclosure.

Given an input x, which can be an image, a video frame, or a sequence of video frames, through a Down-Sample module, the resolution of the input x may be reduced to generate a low-resolution input x_{LR}. An Encoder module may use a compression method to compress the low-resolution input x_{LR} into a stream y_{LR} which may further be transmitted to a Decoder module. Then, y_{LR} may be decompressed by the Decoder module that corresponds to the Encoder module to generate a decoded low-resolution input \hat{x}_{LR}. The Encoder and Decoder modules can use any type of compression methods, including but not limited to, traditional video coding methods such as VVC, DNN-based learned image compression methods, or DNN-based learned video compression methods, etc. The Down-Sample module can use any down-sampling methods, including but not limited to, bi-cubic, down-sampling methods used in traditional video coding methods, or DNN-based down-sampling methods. The present disclosure is not intended to be limiting.

Given the decoded low-resolution input \hat{x}_{LR}, and a set of meta-control variables λₜ^{k}∈Λₜ that reflects the compression quality of \hat{x}_{LR}, a weight vector wₜ^{k} may first be computed by a Meta Weight Generation module based on λₜ^{k}. Then, each kernel may be weighted by the corresponding weight element, and all these weighted kernels ar may be e stacked together into a feature map F_{λ}_{ₜ}_{^{k}}, which may further be passed into a Meta-Control Feature Generation module to compute a meta-control feature vector V_{λ}_{ₜ}_{^{k}}. By using both the low-resolution input \hat{x}_{LR} and the meta-control feature vector V_{λ}_{ₜ}_{^{k}}, a Meta-Control Injected SR module may compute the reconstructed high-resolution \hat{x}.

Based on the original input data x and the reconstructed \hat{x}, a distortion loss L(x,\hat{x}) can be computed. Based on the distortion loss, a Step Size Selection module may determine the step sizes sₜ^{k} for updating the meta-control variables λₜ^{k}. Based on the step sizes and the distortion loss, the direct SGD can be conducted to update the meta-control variables λₜ^{k}:

λₜ^{k}=λₜ^{k}−s^{k}Δ_{λ}_{ₜ}_{^{k}}L(x,\hat{x}), for λₜ^{k}∈Λₜ (4)

Then, this online training process may go into the next iteration. In some examples, the initial values of λₜ^{k} may be set as the target control factors λₜ that generates the low-resolution data \hat{x}_{LR}. After a predefined total number of O online iterations, the optimal Λₜ with the minimum distortion loss L(x,\hat{x}) may be stored as the final meta-control variables. The optimal Λₜ may be transmitted to the decoder, together with the encoded stream y_{LR}.

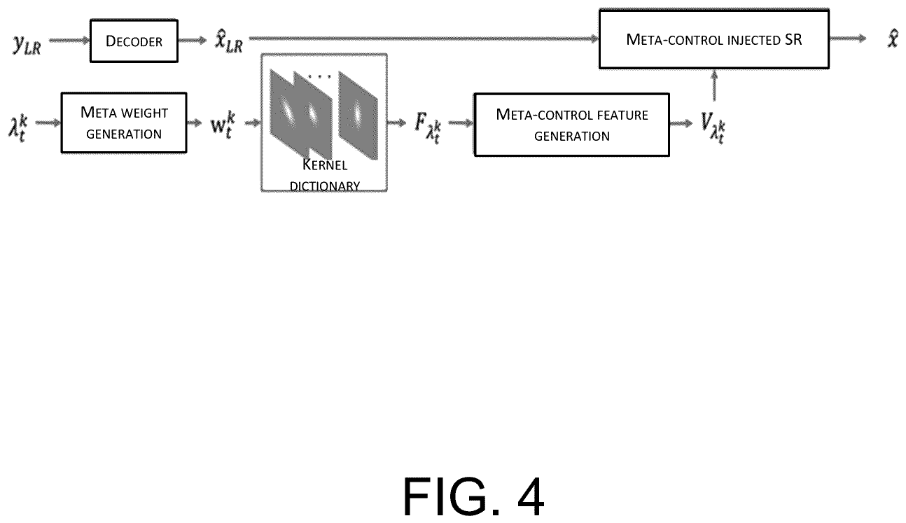

FIG. 4 illustrates an example workflow of a test stage of decoder for online meta-controlled SR according to the present disclosure.

After receiving the transmitted encoded stream y_{LR} and the meta-control variables Λₜ, the decoded low-resolution input \hat{x}_{LR} may first be computed from the stream by the Decoder module, which is usually the same as the Decoder module on the encoder side. Based on the meta-control variables λₜ^{k}∈Λₜ, the weight vector wₜ^{k} may be computed by the Meta Weight Generation module, and the weighted kernel may generate the feature map F_{λ}_{ₜ}_{^{k}}. The Meta-Control Feature Generation module may compute the meta-control feature vector V_{λ}_{ₜ}_{^{k}} based on F_{λ}_{ₜ}_{^{k}}, and the Meta-Control Injected SR module may compute the reconstructed \hat{x} by using both \hat{x}_{LR} and V_{λ}_{ₜ}_{^{k}}.

In some examples, the Meta-Weight Generation module and the Meta-Control Feature Generation module may both have an architecture of Multi-Layer Perception (MLP). A set of anisotropic Gaussian kernels may be used to form the dictionary. Other embodiments can use other types of network structures and other types of kernels.

In some examples, the SR reconstruction network may typically include multiple Residual Blocks (RB), each having multiple convolution and non-linear activation layers with a skip connection directly connecting the input of the RB to the output through a sum operation. In example implementations, the original RB may be modified to a Modulated Residual Block (MRB) to inject the meta-control vector V_{λ}_{ₜ}_{^{k}} into the generation network.

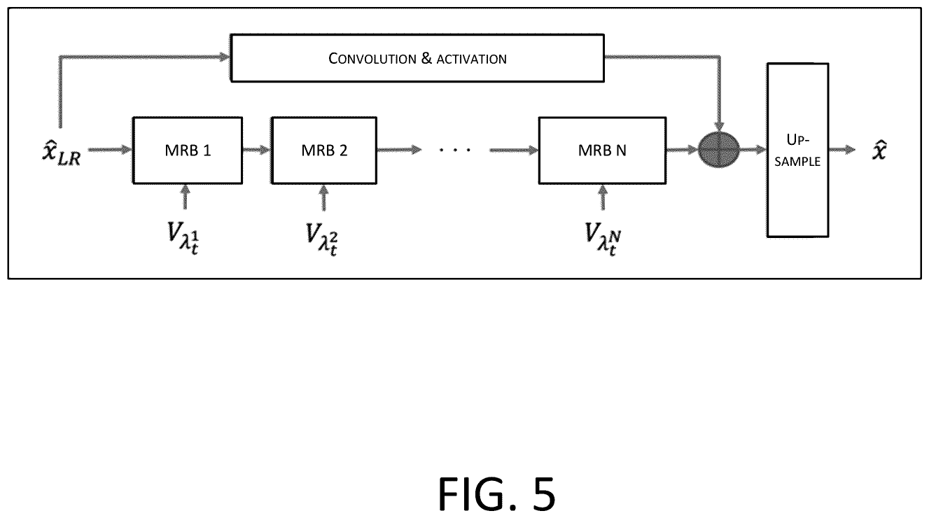

FIG. 5 illustrates an example embodiment of the network structure for the meta-control injected SR according to the present disclosure.

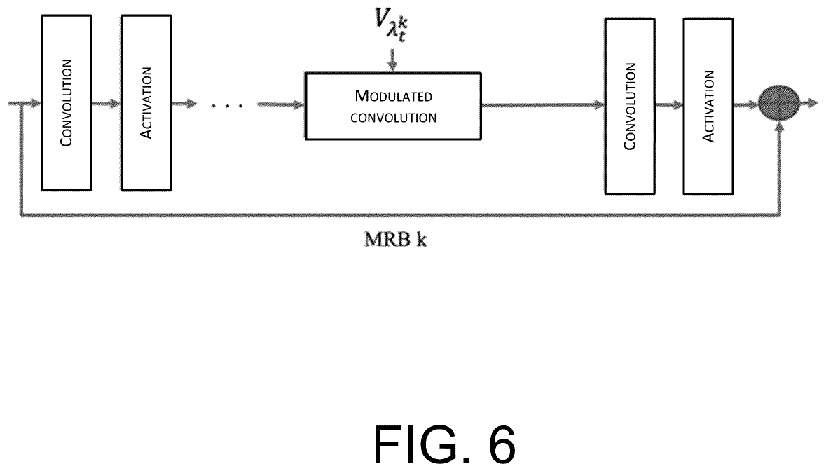

FIG. 6 illustrates an example embodiment of the modulated residual block (MRB) architecture according to the present disclosure. As illustrated in FIG. 6, one or more convolution layers in RB may be replaced by one or more Modulated Convolution Layers in the modulated residual block (MRB).

In some examples, the weight modulation method may be used as the Modulated Convolution Layer, which may make the computation of the output of the Modulated Convolution Layer conditioned on the meta-control vector V_{λ}_{ₜ}_{^{k}}. Other embodiments can use other methods where the Modulated Convolution Layer computes the output of the layer from the input of the layer by conditioning on the control vector.

In the above description, the meta-control variable λₜ^{k} may include various control factors that determine the compression quality of the decoded low-resolution input \hat{x}_{LR}. Such control factors can vary for different coding methods used by the Encoder/Decoder and the Down-Sample modules. For example, the RD tradeoff qp value can be a factor, the various parameters controlling the coding results in traditional or deep image and video coding tools can also be factors. Such factors can also be grouped together, where the meta distribution of compression results are partitioned based on the groups. This disclosure does not put any restriction on the type of control factors or how the meta distribution is defined by such control factors.

In example implementations, an encoder may receive first image data. After receiving the first image data, the encoder may downsample the first image data to second image data. In example implementations, the first image data may include at least one of an image, a video frame, or a sequence of video frames.

In example implementations, the encoder may further encode the second image data to third image data, wherein the third image data may be a bitstream. In example implementations, the encoder may encode the second image data to the third image data using one or more compression methods, the one or more compression methods comprising one or more of: JPEG, JPEG 2000, H.264/MPEG4, H.265/HEVC, VCC, a DNN-based learned image compression method, or a DNN-based learned video compression method.

In example implementations, the encoder may send the third image data to a decoder, which may decode the third image data to fourth image data. In example implementations, the decoder may decode the third image data to the fourth image data using one or more compression methods, the one or more compression methods comprising one or more of: JPEG, JPEG 2000, H.264/MPEG4, H.265/HEVC, VCC, a DNN-based learned image compression method, or a DNN-based learned video compression method. In example implementations, the decoder may reconstruct, as reconstructed image data, the first image data based at least in part on the fourth image data and a feature vector. In example implementations, the decoder may reconstruct, as the reconstructed image data, the first image data based at least in part on the fourth image data and the feature vector using, for example, a meta-controlled super-resolution method.

In example implementations, prior to sending the third image data to the decoder, the encoder may generate a stack of kernels based at least in part on a weight vector, and generate the feature vector based at least in part on the stack of kernels. When sending the third image data to the decoder, the encoder may further send the feature vector to the decoder.

In example implementations, the decoder may obtain a set of parameters indicating a compression quality of the fourth image data, and generate a weight vector based at least in part on the set of parameters. In example implementations, the decoder may compute a distortion loss value based at least in part on the first image data and the reconstructed image data. In example implementations, the decoder may determine a step size based at least in part on the distortion loss value, and update the set of parameters based at least in part on the distortion loss value and the step size.

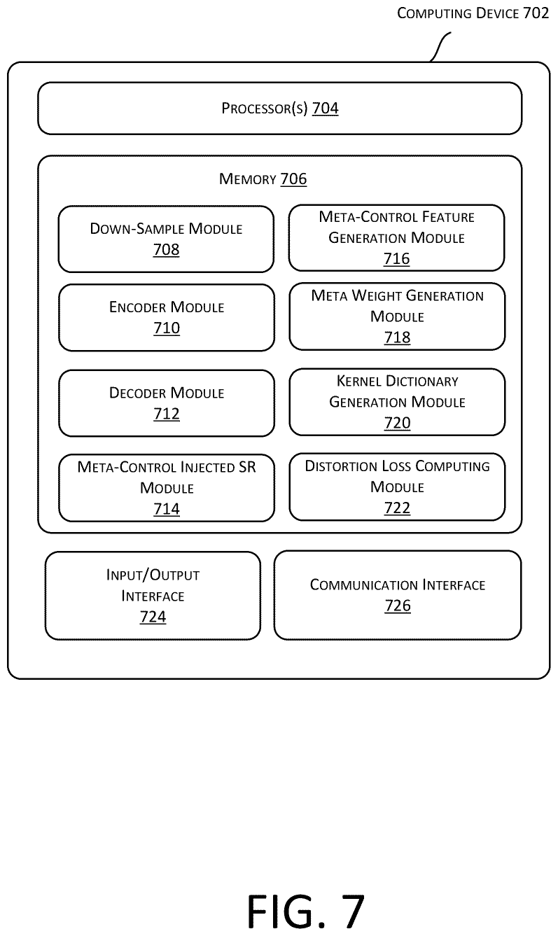

FIG. 7 illustrates an example computing device for implementing the processes and methods described herein for implementing online meta learning for meta-controlled SR in image and video compression.

The techniques and mechanisms described herein may be implemented by multiple instances of the system as well as by any other computing device, system, and/or environment. The computing device 702 shown in FIG. 7 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The computing device 702 may include one or more processors 704 and system memory 706 communicatively coupled to the processor(s) 704. The processor(s) 704 may execute one or more modules and/or processes to cause the processor(s) 704 to perform a variety of functions. In some embodiments, the processor(s) 704 may include a central processing unit (“CPU”), a graphics processing unit (“GPU”), both CPU and GPU, or other processing units or components known in the art. Additionally, each of the processor(s) 704 may possess its own local memory, which also may store program modules, program data, and/or one or more operating systems.

Depending on the exact configuration and type of the computing device 702, the system memory 706 may be volatile, such as RAM, non-volatile, such as ROM, flash memory, miniature hard drive, memory card, and the like, or some combination thereof. The system memory 706 may include one or more computer-executable modules 1206 that are executable by the processor(s) 704.

The memory 706 may include one or more modules programmed to perform certain functions. These modules may include, but are not limited to, a down-sample module 708, an encoder module 710, a decoder module 712, a meta-control injected SR module 714, a meta-control feature generation module 716, a meta weight generation module 718, a kernel dictionary generation module 720, and a distortion loss computing module 722. These modules may be configured to perform any of the methods described above.

The computing device 702 may additionally include an input/output (I/O) interface 724 for receiving video source data and bitstream data, and for outputting decoded pictures into a reference picture buffer and/or a display buffer. The computing device 702 may also include a communication interface 726 allowing the computing device 702 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transitory computer-readable storage media that, when executed by one or more processors, may perform operations described above with reference to FIGS. 1-6. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

The present disclosure can further be understood using the following clauses.
Clause 1: A method implemented by a computing device, the method comprising: receiving first image data; downsampling the first image data to second image data; encoding the second image data to third image data, the third image data being a bitstream; decoding the third image data to fourth image data; and reconstructing, as reconstructed image data, the first image data based at least in part on the fourth image data and a feature vector.
Clause 2: The method of Clause 1, the method further comprising: generating a stack of kernels based at least in part on a weight vector; and generating the feature vector based at least in part on the stack of kernels.
Clause 3: The method of Clause 2, the method further comprising: obtaining a set of parameters indicating a compression quality of the fourth image data; and generating the weight vector based at least in part on the set of parameters.
Clause 4: The method of Clause 3, the method further comprising: computing a distortion loss value based at least in part on the first image data and the reconstructed image data; determining a step size based at least in part on the distortion loss value; and updating the set of parameters based at least in part on the distortion loss value and the step size.
Clause 5: The method of Clause 1, wherein encoding the second image data to the third image data or decoding the third image data to the fourth image data comprises using one or more compression methods, the one or more compression methods comprising one or more of: JPEG, JPEG 2000, H.264/MPEG4, H.265/HEVC, VCC, a DNN-based learned image compression method, or a DNN-based learned video compression method.
Clause 6: The method of Clause 1, wherein the first image data comprises at least one of an image, a video frame, or a sequence of video frames.
Clause 7: The method of Clause 1, wherein reconstructing, as the reconstructed image data, the first image data based at least in part on the fourth image data and the feature vector comprises using a meta-controlled super-resolution method.
Clause 8: The method of Clause 1, wherein the third image data and the feature vector are sent from an encoder to a decoder.
Clause 9: One or more computer readable media storing executable instructions that, when executed by one or more processors, cause the one or more processors to perform acts comprising: receiving first image data; downsampling the first image data to second image data; encoding the second image data to third image data, the third image data being a bitstream; decoding the third image data to fourth image data; and reconstructing, as reconstructed image data, the first image data based at least in part on the fourth image data and a feature vector.
Clause 10: The one or more computer readable media of Clause 9, the acts further comprising: generating a stack of kernels based at least in part on a weight vector; and generating the feature vector based at least in part on the stack of kernels.
Clause 11: The one or more computer readable media of Clause 9, the acts further comprising: obtaining a set of parameters indicating a compression quality of the fourth image data; and generating the weight vector based at least in part on the set of parameters.
Clause 12: The one or more computer readable media of Clause 11, the acts further comprising: computing a distortion loss value based at least in part on the first image data and the reconstructed image data; determining a step size based at least in part on the distortion loss value; and updating the set of parameters based at least in part on the distortion loss value and the step size.
Clause 13: The one or more computer readable media of Clause 9, wherein encoding the second image data to the third image data or decoding the third image data to the fourth image data comprises using one or more compression methods, the one or more compression methods comprising one or more of: JPEG, JPEG 2000, H.264/MPEG4, H.265/HEVC, VCC, a DNN-based learned image compression method, or a DNN-based learned video compression method.
Clause 14: The one or more computer readable media of Clause 9, wherein the first image data comprises at least one of an image, a video frame, or a sequence of video frames.
Clause 15: The one or more computer readable media of Clause 9, wherein reconstructing, as the reconstructed image data, the first image data based at least in part on the fourth image data and the feature vector comprises using a meta-controlled super-resolution method.
Clause 16: The one or more computer readable media of Clause 9, wherein the third image data and the feature vector are sent from an encoder to a decoder.
Clause 17: A system comprising: one or more processors; and memory storing executable instructions that, when executed by the one or more processors, cause the one or more processors to perform acts comprising: receiving first image data; downsampling the first image data to second image data; encoding the second image data to third image data, the third image data being a bitstream; decoding the third image data to fourth image data; and reconstructing, as reconstructed image data, the first image data based at least in part on the fourth image data and a feature vector.
Clause 18: The system of Clause 17, the acts further comprising: generating a stack of kernels based at least in part on a weight vector; and generating the feature vector based at least in part on the stack of kernels.
Clause 19: The system of Clause 17, the acts further comprising: obtaining a set of parameters indicating a compression quality of the fourth image data; and generating the weight vector based at least in part on the set of parameters.
Clause 20: The system of Clause 19, the acts further comprising: computing a distortion loss value based at least in part on the first image data and the reconstructed image data; determining a step size based at least in part on the distortion loss value; and updating the set of parameters based at least in part on the distortion loss value and the step size.

What is claimed is:

1. A method implemented by a computing device, the method comprising:
receiving first image data;
downsampling the first image data to second image data;
encoding the second image data to third image data, the third image data being a bitstream;
decoding the third image data to fourth image data; and
reconstructing, as reconstructed image data, the first image data based at least in part on the fourth image data and a feature vector.

2. The method of claim 1, the method further comprising:
generating a stack of kernels based at least in part on a weight vector; and
generating the feature vector based at least in part on the stack of kernels.

3. The method of claim 2, the method further comprising:
obtaining a set of parameters indicating a compression quality of the fourth image data; and
generating the weight vector based at least in part on the set of parameters.

4. The method of claim 3, the method further comprising:
computing a distortion loss value based at least in part on the first image data and the reconstructed image data;
determining a step size based at least in part on the distortion loss value; and
updating the set of parameters based at least in part on the distortion loss value and the step size.

5. The method of claim 1, wherein encoding the second image data to the third image data or decoding the third image data to the fourth image data comprises using one or more compression methods, the one or more compression methods comprising one or more of: JPEG, JPEG 2000, H.264/MPEG4, H.265/HEVC, VCC, a DNN-based learned image compression method, or a DNN-based learned video compression method.

6. The method of claim 1, wherein the first image data comprises at least one of an image, a video frame, or a sequence of video frames.

7. The method of claim 1, wherein reconstructing, as the reconstructed image data, the first image data based at least in part on the fourth image data and the feature vector comprises using a meta-controlled super-resolution method.

8. The method of claim 1, wherein the third image data and the feature vector are sent from an encoder to a decoder.

9. One or more computer readable media storing executable instructions that, when executed by one or more processors, cause the one or more processors to perform acts comprising:
receiving first image data;
downsampling the first image data to second image data;
encoding the second image data to third image data, the third image data being a bitstream;
decoding the third image data to fourth image data; and
reconstructing, as reconstructed image data, the first image data based at least in part on the fourth image data and a feature vector.

10. The one or more computer readable media of claim 9, the acts further comprising:
generating a stack of kernels based at least in part on a weight vector; and
generating the feature vector based at least in part on the stack of kernels.

11. The one or more computer readable media of claim 9, the acts further comprising:
obtaining a set of parameters indicating a compression quality of the fourth image data; and
generating the weight vector based at least in part on the set of parameters.

12. The one or more computer readable media of claim 11, the acts further comprising:
computing a distortion loss value based at least in part on the first image data and the reconstructed image data;
determining a step size based at least in part on the distortion loss value; and
updating the set of parameters based at least in part on the distortion loss value and the step size.

13. The one or more computer readable media of claim 9, wherein encoding the second image data to the third image data or decoding the third image data to the fourth image data comprises using one or more compression methods, the one or more compression methods comprising one or more of: JPEG, JPEG 2000, H.264/MPEG4, H.265/HEVC, VCC, a DNN-based learned image compression method, or a DNN-based learned video compression method.

14. The one or more computer readable media of claim 9, wherein the first image data comprises at least one of an image, a video frame, or a sequence of video frames.

15. The one or more computer readable media of claim 9, wherein reconstructing, as the reconstructed image data, the first image data based at least in part on the fourth image data and the feature vector comprises using a meta-controlled super-resolution method.

16. The one or more computer readable media of claim 9, wherein the third image data and the feature vector are sent from an encoder to a decoder.

17. A system comprising:
one or more processors; and
memory storing executable instructions that, when executed by the one or more processors, cause the one or more processors to perform acts comprising:
receiving first image data;
downsampling the first image data to second image data;
encoding the second image data to third image data, the third image data being a bitstream;
decoding the third image data to fourth image data; and
reconstructing, as reconstructed image data, the first image data based at least in part on the fourth image data and a feature vector.

18. The system of claim 17, the acts further comprising:
generating a stack of kernels based at least in part on a weight vector; and
generating the feature vector based at least in part on the stack of kernels.

19. The system of claim 17, the acts further comprising:
obtaining a set of parameters indicating a compression quality of the fourth image data; and
generating the weight vector based at least in part on the set of parameters.

20. The system of claim 19, the acts further comprising:
computing a distortion loss value based at least in part on the first image data and the reconstructed image data;
determining a step size based at least in part on the distortion loss value; and
updating the set of parameters based at least in part on the distortion loss value and the step size.
